(19) United States
(12) Patent Application Publication
(10) Pub. No.: US 2025/0060130 A1
(43) Pub. Date: Feb. 20, 2025

(54) CONDENSING HEAT EXCHANGER AND WATER HEATING/HEATING DEVICE

(71) Applicants: A.O. SMITH (CHINA) WATER HEATER CO., LTD., Nanjing Jiangsu (CN); A.O. SMITH (CHINA) WATER PRODUCTS CO., LTD., Nanjing Jiangsu (CN)

(72) Inventors: Xiaochuan ZHENG, Nanjing Jiangsu (CN); Dian FANG, Nanjing Jiangsu (CN); Lifu ZHU, Nanjing Jiangsu (CN)

(21) Appl. No.: 18/723,313

(22) PCT Filed: Nov. 15, 2022
(86) PCT No.: PCT/CN2022/131870

§ 371 Date: Jun. 21, 2024

(30) Foreign Application Priority Data
Dec. 29, 2021 (CN) 202111643158.7

(51) Int. Cl. F24H 8/00; F24H 1/00; F28D 7/16; F28F 1/12

(52) U.S. Cl. CPC F24H 8/006; F24H 1/0036; F28D 7/16; F28F 1/12

(57) ABSTRACT

The disclosure discloses a condensing heat exchanger and a water heating/heating device thereof. The condensing heat exchanger includes: a housing including a first end portion and a second end portion opposite to each other, and a side wall arranged between the first end portion and the second end portion, the second end portion being provided with a mounting portion for mounting a combustor; a smoke outlet arranged on the housing; a heat exchange component arranged inside the housing; and a first heat insulating member arranged close to the first end portion. A first gap is provided between the first heat insulating member and the first end portion, and at least part of smoke which has exchanged heat with the heat exchange component can flow through the first gap and be discharged from the smoke outlet. This application improves reliability of the condensing heat exchanger and the water heating/heating device thereof and reduces the cost by optimizing an internal structure of the condensing heat exchanger on the premise of ensuring the heat insulating and cooling effect.

### RELATED APPLICATIONS

The application claims the priority of Chinese patent application No. 202111643158.7, entitled “CONDENSING HEAT EXCHANGER AND WATER HEATING/HEATING DEVICE”.

### FIELD OF THE DISCLOSURE

The disclosure relates to the field of water heating, and in particular to a condensing heat exchanger and a water heating/heating device.

### BACKGROUND

At present, gas combustion devices have been widely used as a typical water heating device. Specifically, the gas combustion devices are classified into many forms, among which, a condensing gas water heater, as an efficient gas combustion device, has great potential of saving energy. Compared with common gas combustion devices, the condensing gas water heater is provided with a condensing heat exchanger which can fully absorb heat of high-temperature smoke, improving the heat exchange efficiency of the whole machine.

However, the structure of the existing condensing heat exchanger still needs to be further optimized, so as to comprehensively improve the reliability of the condensing heat exchanger and reduce the cost on the premise of ensuring the basic functions (such as the heat insulating and cooling effect).

### SUMMARY

In view of the above problem, an objective of the disclosure is to provide a condensing heat exchanger and a water heating/heating device thereof, so as to improve the reliability of the condensing heat exchanger and the water heating/heating device thereof and reduce the cost by optimizing an internal structure of the condensing heat exchanger on the premise of ensuring the heat insulating and cooling effect.

In order to achieve the above objective, the technical solutions of the disclosure are set forth as follows:

A condensing heat exchanger includes: a housing including a first end portion and a second end portion opposite to each other, and a side wall arranged between the first end portion and the second end portion, the second end portion being provided with a mounting portion for mounting a combustor; a smoke outlet arranged on the housing; a heat exchange component arranged inside the housing; and a first heat insulating member arranged close to the first end portion. A first gap is provided between the first heat insulating member and the first end portion, and at least part of smoke which has exchanged heat with the heat exchange component can flow through the first gap and be discharged from the smoke outlet.

A water heating/heating device includes: the condensing heat exchanger as described above and a combustor. The combustor and the condensing heat exchanger are fixed on a combustion door which is fitted and fixed to a first end portion of the condensing heat exchanger by means of a sealing structure.

Compared with the prior art, the disclosure has the following beneficial effects:

According to the condensing heat exchanger provided by this application, the first gap is provided between the first heat insulating member and the first end portion, and at least part of the smoke which has exchanged heat with the heat exchange component can flow through the first gap and be discharged from the smoke outlet. Since the temperature of the high-temperature smoke will be significantly reduced after the high-temperature smoke has exchanged heat with the heat exchange component, while the cooled smoke flows through the first gap, on the one hand, the first heat insulating member can be cooled, and part of heat of the first heat insulating member can be taken away, and on the other hand, the cooled smoke to be discharged can cooperate with the first heat insulating member to perform a significant cooling and heat insulating effect on the first end portion.

In addition, since the first gap is additionally provided, the requirement for heat insulating performance of the first heat insulating member is lowered on the premise of achieving the same heat insulating and cooling effect. Since the requirement for the heat insulating performance of the first heat insulating member is lowered, the first heat insulating member can be simplified to have a relatively regular outer contour, which is, for example, in the shape of a regular circle along the axis direction, as compared with the original special-shaped heat insulating member (e.g., special-shaped vermiculite) plugged between the heat exchange component and the first end portion. By optimizing the structure as described above, it is possible that the first heat insulating member does not directly contact condensed water flowing out of the heat exchange component, thereby improving the reliability; and moreover, the material consumption can be reduced, and the production difficulty can be lowered, thereby reducing the cost.

### BRIEF DESCRIPTION OF THE DRAWINGS

FIG. 1 is a schematic structural view of a condensing heat exchanger according to an example of the disclosure;

FIG. 2 is an exploded view of the condensing heat exchanger according to the example of the disclosure;

FIG. 3 is a schematic exploded sectional view of the condensing heat exchanger according to the example of the disclosure;

FIG. 4 is a sectional view of FIG. 1;

FIG. 5 a schematic view showing smoke flow inside the condensing heat exchanger of FIG. 4;

FIG. 6 a schematic structural view of a condensing heat exchanger according to another example of the disclosure; and

FIG. 7 a schematic structural view of a condensing heat exchanger according to still another example of the disclosure.

### LIST OF REFERENCE SIGNS

110 housing;

111 first end portion;

112 second end portion;

113 side wall;

114 smoke outlet;

115 mounting portion;

X axis direction;

116 drainage groove;

117 water outlet;

120 heat exchange component;

121 inner-layer heat exchange tube;

122 outer-layer heat exchange tube;

130 first heat insulating member;

140 second heat insulating member;

141 water-cooled smooth tube;

142 air chamber;

151 first gap;

152 second gap;

153 third gap;

154 fourth gap;

161 first deflector;

162 second deflector;

163 third deflector;

Y height direction;

170 connecting portion;

200 combustor.

### DESCRIPTION OF THE EMBODIMENTS

In order to make those skilled in the art better understand the technical solutions in the disclosure, the technical solutions in the examples of the disclosure will be clearly and completely described below in conjunction with the accompanying drawings in the examples of the disclosure. It is apparent that the described examples are merely some, but not all the examples of the disclosure. All other examples obtained by those of ordinary skill in the art based on the examples in the disclosure without creative efforts shall fall within the protection scope of the invention.

It should be noted that when an element is referred to as being “arranged on” another element, it may be directly on the another element or an intervening element may be present. When an element is considered to be “connected to” another element, it can be directly connected to the another element or an intervening element may be present at the same time. The terms “vertical”, “horizontal”, “left”, “right”, and similar expressions used herein are for illustration purposes only, and do not represent the only embodiment.

Unless otherwise defined, all technical and scientific terms used herein have the same meaning as commonly understood by those skilled in the art of the disclosure. The terms used in the specification of the disclosure are only for the purpose of describing specific embodiments and are not intended to limit the disclosure. The term “and/or” used herein includes any and all combinations of one or more related listed items.

A common condensing heat exchanger uses a high-temperature-resistant heat-insulating material at its end portions for heat insulation. For example, the existing condensing heat exchanger uses a special-shaped heat insulating member plugged between the whole heat exchange component and the end portions so as to achieve an ideal heat insulation effect. The inventors have found that during the use of the condensing gas water heater, the special-shaped heat insulating member has the defects of high material consumption, high production difficulty, and high overall cost.

In addition, when the special-shaped heat insulating member is made of some materials that tend to lose efficacy when exposed to water (e.g., vermiculite), a part of the special-shaped vermiculite that is attached to the heat exchange component will directly contact condensed water. After the special-shaped vermiculite contacts the condensed water, the structure will fall apart so as to lose efficacy, i.e., lose its heat insulation function, which leads to low reliability of the condensing heat exchanger. Therefore, this application provides a condensing heat exchanger and a water heating/heating device thereof, so as to improve the condensing heat exchanger and the water heating/heating device thereof and reduce the cost by optimizing an internal structure of the condensing heat exchanger on the premise of ensuring the heat insulating and cooling effect.

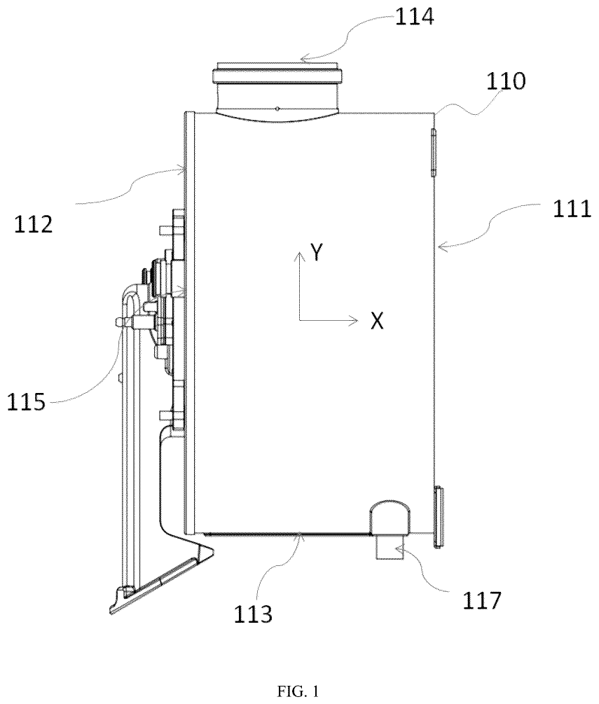

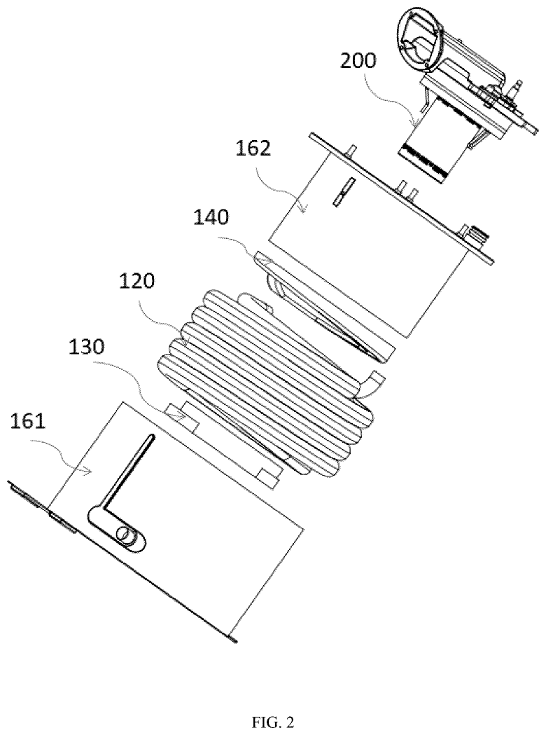

Referring to FIGS. 1 to 7, an embodiment of the disclosure provides a condensing heat exchanger. The condensing heat exchanger may include: a housing 110 including a first end portion 111 and a second end portion 112 opposite to each other, and a side wall 113 arranged between the first and second end portions 111, 112, the second end portion 112 being provided with a mounting portion 115 for mounting a combustor 200; a smoke outlet 114 arranged on the housing 110; a heat exchange component 120 arranged inside the housing 110; and a first heat insulating member 130 arranged close to the first end portion 111. A first gap 151 is provided between the first heat insulating member 130 and the first end portion 111, and at least part of smoke which has exchanged heat with the heat exchange component 120 can flow through the first gap 151 and be discharged from the smoke outlet 114.

As shown in FIGS. 1-3, a hollow chamber is formed inside the housing 110 and configured to accommodate the heat exchange component 120, the first heat insulating member 130, the combustor 200 and the like. Specifically, the whole housing 110 may be in the shape of a hollow cylinder. Of course, the shape of the housing 110 may also be adaptively adjusted and designed according to the actual mounting space, which is not specifically limited in this application. In this specification, by way of example, the housing 110 is mainly described with the shape and structure as shown in the accompanying drawings of the specification. When the housing 110 is configured with other shapes and structures, reference may be made to the examples in this specification, and this application will not describe them in detail.

Specifically, the housing 110 may include the first end portion 111 and the second end portion 112 opposite to each other, and the side wall 113 arranged between the first and second portions 111, 112. When the condensing heat exchanger is in a mounted state, the first end portion 111 may be located on a side close to the user (i.e., the first end portion 111 is a front end portion), and the second end portion 112 may be located on a side away from the user (i.e., the second end portion 112 is a rear end portion). The second end portion 112 is provided with the mounting portion 115 for mounting the combustor 200. The mounting portion 115 may include an opening provided at the second end portion 112. Of course, the mounting portion 115 may further include a connecting structure (e.g., a quick connector) or the like matched with the combustor 200. Specifically, the form of the connecting structure is not specifically limited in this application.

The housing 110 is further provided with the smoke outlet 114 for leading the smoke which has exchanged heat with the heat exchange component 120 out of the condensing heat exchanger. Specifically, the smoke outlet 114 may be arranged at a top of the side wall 113, so that the smoke can be efficiently discharged along the flow direction. Of course, the smoke outlet 114 may also be provided at other positions. The specific position of the smoke outlet 114 may depend on the specific arrangement of a smoke flow channel inside the heat exchanger, which is not specifically limited in this application.

In addition, the side wall 113 is further provided with a water outlet 117 for discharging condensed water generated by the heat exchange component 120 out of the condensing heat exchanger. Specifically, the water outlet 117 may be arranged at a bottom of the side wall 113, so that the condensed water can be efficiently and thoroughly discharged out of the housing 110 by gravity, which avoids accumulation. Of course, in some embodiments, the water outlet 117 may also be provided at other positions of the side wall 113.

In a specific embodiment, the side wall 113 of the housing 110 is provided with a drainage groove 116, which is provided at a lowest point thereof with the water outlet 117.

When the side wall 113 of the housing 110 is provided with the drainage groove 116 and the water outlet 117 is located at the lowest point of the drainage groove 116, it can be ensured that the condensed water can be smoothly discharged even when there is an error in mounting the condensing heat exchanger, for example, when the condensing heat exchanger (or the housing 110) tilts forward or backward along an axis direction X. The axis direction X of the housing 110 may extend substantially along the horizontal plane. Of course, considering the actual mounting error and mounting environment, the axis may form an angle with the horizontal plane. The drainage groove 116 may extend substantially along the axis direction X of the housing 110.

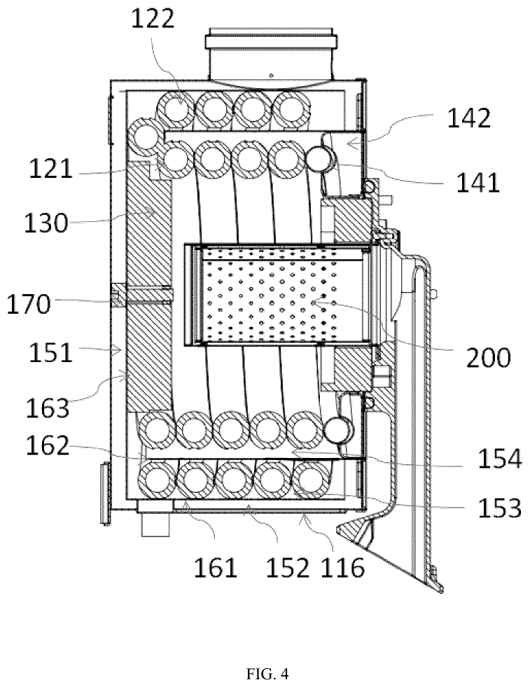

In this embodiment, the heat exchange component 120 is a main part of the condensing heat exchanger which conducts heat exchange with the high-temperature smoke. Specifically, the heat exchange component 120 may be in the form of a heat exchange coil which is formed in the middle thereof with a combustion chamber for mounting the combustor 200, and at least part of the first heat insulating member 130 is located in the combustion chamber. As shown in FIG. 4, along the axis direction X, the first heat insulating member 130 may be completely located in the combustion chamber formed by the heat exchange coil. For example, the first heat insulating member 130 has a first surface and a second surface opposite to each other along a thickness direction. The second surface of the first heat insulating member 130 may be flush or nearly flush with the heat exchange component 120 on the surface perpendicular to the axis direction X, which can reduce the size of the condensing heat exchanger along the axis direction X. Of course, in other embodiments, along the axis direction X, the first heat insulating member 130 may be partially located in the combustion chamber.

The heat exchange coil in the heat exchange component 120 may be in the form of a single-layer heat exchange tube, a double-layer heat exchange tube or a multi-layer heat exchange tube according to the number of layers wound. In addition, the heat exchange coil may include any one or combination of a threaded tube, a smooth tube, a finned tube, a D-shaped heat exchange coil, etc. In the specific embodiments of this application, different embodiments described are described in detail based on different number of layers and/or forms of the heat exchange component 120.

In this embodiment, the first heat insulating member 130 is arranged close to the first end portion 111.

Specifically, the first heat insulating member 130 may be in clearance fit with the heat exchange component 120. When the first heat insulating member 130 is in clearance fit with the heat exchange component 120, the condensed water generated on the heat exchange component 120 can be prevented from directly contacting the first heat insulating member 130.

Further, along a height direction Y, a blocking member is further arranged between a top of the first heat insulating member 130 and the heat exchange component 120. Even if some condensed water flows down by gravity, it will drip on the blocking member and finally be discharged through the water outlet 117.

In the case where the heat exchange coil is a double-layer heat exchange tube, the surface of an inner-layer heat exchange tube 121 is generally in a high-temperature state, so it is generally less likely to generate condensed water; and for an outer-layer heat exchange tube 122, there may be condensed water in some areas. Therefore, the blocking member may be arranged close to the first end portion 111 and used for receiving the condensed water that may drip from the outer-layer heat exchange tube 122.

Specifically, the first heat insulating member 130 may be plunger-shaped as a whole, and a shape of an outer contour of the heat insulating member matches a shape of an inner contour of the heat exchange component 120. The first heat insulating member 130 may be made of a high-temperature-resistant material. For example, the material of the first heat insulating member 130 may include any one or combination of vermiculite, refractory bricks, quartz and fiberglass. In the embodiments below; the description is mainly made in an example where the first heat insulating member 130 is made of vermiculite.

In this embodiment, a first gap 151 is provided between the first heat insulating member 130 and the first end portion 111, and at least part of smoke which has exchanged heat with the heat exchange component 120 can flow through the first gap 151 and be discharged from the smoke outlet 114. Since the temperature of the high-temperature smoke will be significantly reduced after the high-temperature smoke has exchanged heat with the heat exchange component 120, as the cooled smoke flows through the first gap 151, on the one hand, the first heat insulating member 130 can be cooled, and part of heat of the first heat insulating member 130 can be taken away, and on the other hand, the cooled smoke to be discharged can cooperate with the first heat insulating member 130 to perform a significant cooling and heat insulating effect on the first end portion 111.

In addition, since the first gap 151 is additionally provided, the requirement for heat insulating performance of the first heat insulating member 130 is lowered on the premise of achieving the same heat insulating and cooling effect. Since the requirement for the heat insulating performance of the first heat insulating member 130 is lowered, the first heat insulating member 130 can be simplified to have a relatively regular outer contour, which is, for example, in the shape of a regular circle along the axis direction, as compared with the original special-shaped heat insulating member (e.g., special-shaped vermiculite) plugged between the heat exchange component 120 and the first end portion 111. By optimizing the structure as described above, it is possible that the first heat insulating member 130 does not directly contact condensed water flowing out of the heat exchange component 120, thereby improving the reliability; and moreover, the material consumption can be reduced, and the production difficulty can be lowered, thereby reducing the cost.

In order to ensure that the smoke flowing through the first gap 151 is lower-temperature smoke after exchanging heat with the heat exchange component 120, a third deflector 163 is arranged between the first heat insulating member 130 and the housing 110. Specifically, the first heat insulating member 130 is provided with the third deflector 163 close to the first end portion 111, and the first gap 151 is formed between the third deflector 163 and the first end portion 111. That is, the first gap 151 is formed between the third deflector 163 and an inner wall of the first end portion 111 of the housing 110, and the third deflector 163 is provided at an end close to the side wall 113 with an intake inlet for smoke to flow into the first gap 151. There may be an annular intake inlet arranged along the whole circumference or intake inlets spaced apart in some areas, which is not limited herein. The third deflector 163 may be fixedly arranged at one end of the first heat insulating member 130. Of course, in other alternative embodiments, the third deflector 163 may also be arranged on the inner wall of the first end portion 111 of the housing 110 by means of a supporting member, which is not limited herein.

In this embodiment, in order to further reduce the temperature of the smoke flowing through the first gap 151, a first deflector 161 is further arranged between the heat exchange component 120 and the housing 110. The first deflector 161 is hermetically connected with the third deflector 163, so that the high-temperature smoke cannot directly flow to the first gap 151 along the axis direction. The third deflector 163 may be in the shape of a plate with a certain thickness as a whole, and a shape of an outer contour of the third deflector 163 may be matched with that of a cross-section of the first deflector 161. Of course, the shape and structure of the third deflector 163 may also be adaptively designed according to needs, which is not limited herein, as long as it can block an end of the first deflector 161 close to the first end portion 111. A material of the third deflector 163 may be sheet metal, and of course, may also be other high-temperature-resistant materials. The hermetic connection may be implemented by welding, or the third deflector 163 may be integrally formed with the first deflector 161. Of course, the third deflector 163 and the first deflector 161 may also be hermetically connected by other means, which is not specifically limited herein. When the first gap 151 is formed by means of the fit between the third deflector 163 and the first end portion 111 and the third deflector 163 is hermetically connected with the first deflector 161, the first heat insulating member 130 may be arranged only in a high-temperature area relative to the combustion chamber, so that the first heat insulating member 130 can have a smaller and more regular outer contour.

In addition, in other embodiments, the first gap 151 may also be formed by other means. For example, the first gap 151 may be directly formed by the first heat insulating member 130 and the first end portion 111. When the first gap 151 is directly formed by the first heat insulating member 130 and the first end portion 111, a periphery of the first heat insulating member 130 may be attached to the side wall 113 of the housing 110 or arranged in close proximity to the side wall 113 of the housing 110, or an inner side of the side wall 113 of the housing 110 is provided with a mounting structure for mounting the first heat insulating member 130, the mounting structure, the first heat insulating member 130, and the first end portion 111 forming the first gap 151.

In an embodiment, a second gap 152 is provided between the heat exchange component 120 and the side wall 113. The second gap 152 is in communication with the first gap 151.

In this embodiment, the second gap 152 may be provided between the heat exchange component 120 and the side wall 113 of the housing 110. The second gap 152 is in communication with the first gap 151. Along the flow direction of the smoke, the second gap 152 may be located upstream of the first gap 151, that is, after the high-temperature smoke exchanges heat with the heat exchange component 120, at least part of the high-temperature smoke may sequentially pass through the second gap 152 and the first gap 151 and finally be discharged from the smoke outlet 114. Alternatively, along the flow direction of the smoke, the second gap 152 may be located downstream of the first gap 151, that is, after the high-temperature smoke exchanges heat with the heat exchange component 120, at least part of the high-temperature smoke may sequentially pass through the first gap 151 and the second gap 152 and finally be discharged from the smoke outlet 114. Alternatively, the second gap 152 and the first gap 151 form two independent smoke flow channels, that is, after the high-temperature smoke exchanges heat with the heat exchange component 120, part of the high-temperature smoke may pass through the first gap 151 and be discharged from the smoke outlet 114, and part of the high-temperature smoke may pass through the second gap 152 and be discharged from the smoke outlet 114. Alternatively, along the flow direction of the smoke, the first gap 151 is located neither upstream nor downstream of the second gap 152, and the overall flow of the smoke depends on the specific arrangement of the deflectors and the smoke outlet 114 in the housing 110. For example, at least part of the smoke may subsequently flow through the second gap 152, the first gap 151, and the second gap 152 again, and finally be discharged from the smoke outlet 114.

Specifically, in the case where at least part of the smoke which has exchanged heat with the heat exchange component 120 can sequentially flow through the second gap 152 and the first gap 151 and be discharged from the smoke outlet 114, after the second gap 152 is in communication with the first gap 151, the high-temperature smoke flowing out of the combustor 200 after exchanging heat with the heat exchange component 120 may firstly flow through the second gap 152 for sufficient heat exchange and cooling, and then flow into the first gap 151 in communication with the second gap 152, so that the smoke flowing into the first gap 151 can have a relatively low temperature. When the smoke with a relatively low temperature flows into the first gap 151, a significant heat dissipation and cooling effect can be produced on the first end portion 111.

In an embodiment, the first deflector 161 is arranged between an outer side of the heat exchange component 120 and the side wall 113 of the housing 110, and the second gap 152 is formed between the first deflector 161 and the inner side wall 113 of the housing 110.

Specifically, the first deflector 161 may surround a periphery of the heat exchange component 120. The shape and structure of the first deflector 161 may be matched with the outer contour of the heat exchange component 120. For example, when the outer contour of the heat exchange component 120 is cylinder-shaped, the first deflector 161 may be in a hollow tube structure. Of course, the shape and structure of the first deflector 161 are not limited to the example above, and may be adaptively adjusted by those skilled in the art according to actual design needs.

The second gap 152 is provided between the first deflector 161 and the inner side wall 113 of the housing 110. The second gap 152 may be used for the flow of the smoke which has exchanged heat with the heat exchange component 120. The first gap 151 is larger than the second gap 152. Since the first gap 151 is larger than the second gap 152, the flow resistance of the fluid in the first gap 151 is smaller than that in the second gap 152, so that more smoke that flows into the second gap 152 after exchanging heat with the heat exchange component 120 can flow into the first gap 151, i.e., there can be sufficient smoke flowing in the first gap 151, thereby producing a more significant heat dissipation and cooling effect on the first end portion 111.

It should be noted that specific values of the first gap 151 and the second gap 152 may depend on the actual structure and size of the condensing heat exchanger, which is not specifically limited herein. In other alternative embodiments, the first gap 151 may be smaller than or equal to the second gap 152. For the embodiment in which both the second gap 152 and the first gap 151 are provided, when the first gap 151 is formed between the third deflector 163 and the first end portion 111 and the first deflector 161 is hermetically connected with the third deflector 163, the high-temperature smoke can sufficiently exchange heat with the heat exchange component 120 and then flow through the second gap 152 to the first gap 151, i.e., the high-temperature smoke can be prevented from directly flowing into the first gap 151.

In a specific embodiment, the side wall 113 and the first end portion 111 form a first sleeve with an opening at one end, and the first deflector 161 and the third deflector 163 form a second sleeve with an opening at one end. The first sleeve surrounds the second sleeve, and a connecting portion 170 is arranged between the first and second sleeves.

In this embodiment, the side wall 113 and the first end portion 111 may form the first sleeve with the opening at one end. Specifically, the side wall 113 and the first end portion 111 may be integrally formed or may be hermetically connected by other means such as welding. The first deflector 161 and the third deflector 163 form the second sleeve with the opening at one end. The openings of the first sleeve and the second sleeve face the same direction, and the first sleeve surrounds the second sleeve. The connecting portion 170 may be arranged between the first sleeve and the second sleeve. By using the connecting portion 170, the second sleeve can be positioned relative to the first sleeve. Specifically, the connecting portion 170 may be in the form of a stud. For example, an end of the stud provided with a nut may be fixed to the first end portion 111, and an end provided with the stud extend along the axis direction. The third deflector 163 of the second sleeve is provided with an opening matched with the stud. The specific form of the connecting portion 170 is not limited to the example above, and may be other feasible solutions. In addition, the number of the connecting portions 170 may be one or more, which is not specifically limited herein.

Further, the first heat insulating member 130 has a first surface and a second surface opposite to each other along a thickness direction. The first surface is configured to be spaced apart from the combustor 200 at a predetermined distance, and the third deflector 163 is attached to the second surface.

In this embodiment, the third deflector 163 is attached to the second surface of the first heat insulating member 130, and the first surface of the first heat insulating member 130 is spaced apart from the combustor 200 at a predetermined distance. The predetermined distance may be determined according to the thickness sizes of the combustor 200, the heat exchange component 120, and the first heat insulating member 130, and the specific value is not specifically limited herein.

In addition, the connecting portion 170 may further include an extending portion extending away from the first end portion 111, and the first heat insulating member 130 is mounted on the extending portion.

In this embodiment, in an example where the connecting portion 170 is in the form of a stud, when the connecting portion 170 is a stud, an end provided with a nut may be fixed to the first end portion 111, and an end provided with the stud may run through the third deflector 163 and extend out. The extending portion may be a section of the stud extending out of the third deflector 163. The first heat insulating member 130 may be mounted on the stud. When the connecting portion 170 and the extending portion are in the form of a stud, the first sleeve, the second sleeve, and the first heat insulating member 130 may be positioned by using the stud, which is simple in mounting and compact in structure. Moreover, since the stud has a relatively small size, there is less interference with the flow of the smoke in the first gap 151.

In an embodiment, the condensing heat exchanger may further include a second heat insulating member 140 arranged close to the second end portion 112.

In this embodiment, the second heat insulating member 140 may further be arranged close to the second end portion 112 of the housing 110. Since the second end portion 112 faces the user, it is required to reduce the temperature of the second end portion 112 to a safe temperature, which avoids hurting the user when the user accidentally contacts the second end portion. Specifically, the second heat insulating member 140 may be arranged between the heat exchange component 120 and the second end portion 112 in many forms. For example, the second heat insulating member 140 may include a water-cooling smooth tube 141 arranged between the heat exchange component 120 and the second end portion 112. A circulating liquid (e.g., circulating water) flows in the water-cooling smooth tube 141. The circulating water may be in communication with the water in the heat exchange component 120, i.e., a water inlet and a water outlet of the water-cooling smooth tube 141 are in communication with the heat exchange component 120. Of course, the water in the water-cooling smooth tube 141 may also be supplied by an independent system. The cooling water circulating in the water-cooling smooth tube 141 may be used for cooling the second end portion 112.

Further, the second heat insulating member 140 may further include any one or combination of vermiculite, an air chamber 142, and a cooling liquid chamber arranged between the water-cooling smooth tube 141 and the second end portion 112.

In this embodiment, the second heat insulating member 140 may be formed by means of the fit between the water-cooling smooth tube 141 and other heat insulating parts. For example, the air chamber 142 and the water-cooling smooth tube 141 may be sequentially arranged between the second end portion 112 and the heat exchange component 120. The air chamber 142 is used for heat insulation, and the water-cooling smooth tube 141 is used for heat absorption by water cooling, so that a heat insulating and cooling effect equivalent to the vermiculite used alone can be obtained. When the second heat insulating member 140 is formed by means of the fit between the water-cooling smooth tube 141 and other forms of heat insulating parts, a heat insulating and cooling effect equivalent to the vermiculite used alone can also be obtained.

In the case where the second heat insulating member 140 is not provided with the vermiculite, a heat insulating and cooling effect equivalent to the vermiculite used alone can be obtained, and the problem of poor reliability of the vermiculite can be solved fundamentally. In the case where the second heat insulating member 140 includes not only the water-cooling smooth tube 141 but also the vermiculite, since the water-cooling smooth tube 141 is arranged, the requirement for the heat insulating performance of the vermiculite is lowered, the size of the vermiculite can be reduced, and the reliability of the vermiculite can be improved to some extent.

In the embodiments below; by way of example, different forms of the heat exchange component 120 will be mainly described in detail.

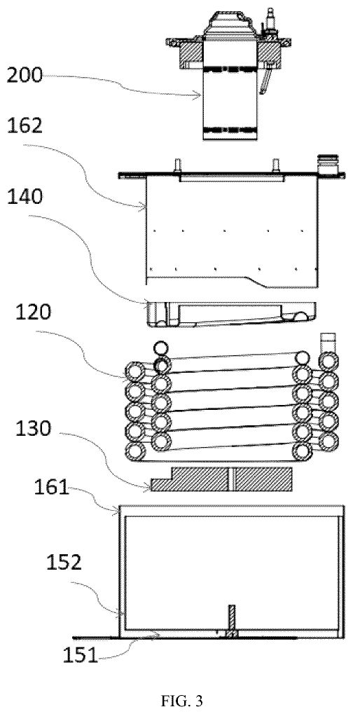

Referring to FIG. 3 to FIG. 4, in an embodiment, the heat exchange component 120 is a double-layer heat exchange tube, including an inner-layer heat exchange tube 121 and an outer-layer heat exchange tube 122 arranged outside the inner-layer heat exchange tube 121.

In this embodiment, the heat exchange component 120 may be a double-layer heat exchange tube. When the heat exchange component 120 is a double-layer heat exchange tube, it may include: the inner-layer heat exchange tube 121 and the outer-layer heat exchange tube 122. A second deflector 162 is arranged between the inner-layer heat exchange tube 121 and the outer-layer heat exchange tube 122.

In this embodiment, by way of example, the heat exchange tube in the heat exchange component 120 mainly in the form of a finned tube with high heat exchange efficiency will be described in detail. For other forms, reference may be made to this embodiment, and this disclosure will not describe them in detail. When the heat exchange tube is a finned tube, a plurality of first fins are provided on the outer surface of the inner-layer heat exchange tube 121, and a plurality of second fins are provided on the outer surface of the outer-layer heat exchange tube 122.

In this embodiment, the second deflector 162 is arranged between the inner-layer heat exchange tube 121 and the outer-layer heat exchange tube 122.

Specifically, the second deflector 162 may be in a hollow sleeve structure. The second deflector 162 is hermetically connected at one end thereof with the second end portion 112 (for example, by welding), and a certain deflection gap is formed between the other end of the second deflector 162 and the third deflector 163. The deflection gap is used for forming a communication portion for guiding the condensed water generated by the second deflector 162 to the first deflector 161.

The first deflector 161 is arranged between the outer-layer heat exchange tube 122 and the side wall 113 of the housing 110. The first deflector 161 is hermetically connected at one end thereof with the third deflector 163 (for example, by welding), and at the other end thereof in a clearance fit with the second end portion 112. The gap formed between the first deflector 161 and the second end portion 112 is used for forming a smoke deflection port between the heat exchange component 120 and the first deflector 161. The high-temperature smoke flowing out of the combustor 200 after exchanging heat with the heat exchange component 120 flows into the second gap 152 through the smoke deflection port, and the smoke subsequently flowing into the second gap 152 can at least partially flow into the first gap 151.

In this embodiment, the condensed water that may be generated on the inner-layer heat exchange tube 121 during the heat exchange process of the smoke drips into the second deflector 162, and the condensed water on the second deflector 162 flows to the first deflector 161 through the deflection gap. Moreover, the condensed water generated on the outer-layer heat exchange tube 122 also flows into the first deflector 161. The two parts of condensed water flow through the first deflector 161 and are finally discharged out of the housing 110 via the water outlet 117.

In a specific embodiment, a third gap 153 is formed between an inner wall of the first deflector 161 and an outer surface of the outer-layer heat exchange tube 122, and a fourth gap 154 is formed between an inner wall of the second deflector 162 and an outer surface of the inner-layer heat exchange tube 121. The fourth gap 154, the third gap 153, the second gap 152, and the first gap 151 can be sequentially in communication.

In this embodiment, the third gap 153 is formed between the inner wall of the first deflector 161 and the outer surface of the outer-layer heat exchange tube 122. The third gap 153 may be used for the flow of the smoke and the condensed water. The specific value of the third gap 153 may depend on the internal structure of the first deflector 161 and the shape of the outer contour of the outer-layer heat exchange tube 122, which is not specifically limited herein.

The fourth gap 154 is formed between the inner wall of the second deflector 162 and the outer surface of the inner-layer heat exchange tube 121. The fourth gap 154 is mainly used for the flow of the smoke. The specific value of the fourth gap 154 may depend on the internal structure of the second deflector 162 and the shape of the outer contour of the inner-layer heat exchange tube 121, which is not specifically limited herein.

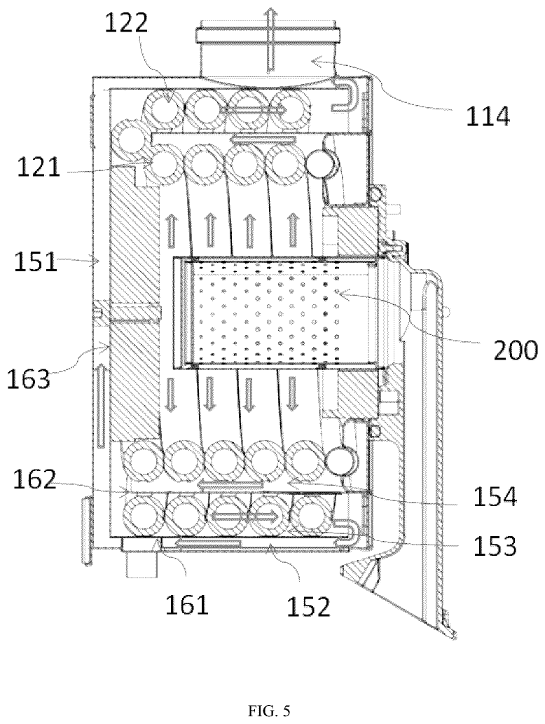

Referring to FIG. 5, the changes of the smoke temperature are verified by using the condensing heat exchanger as follows: along the flow direction of the smoke, the fourth gap 154, the third gap 153, the second gap 152, and the first gap 151 can be sequentially in communication. Specifically, the high-temperature smoke with a temperature of about 1100° C. flowing out of the combustor 200 spreads around, and first comes into contact with the inner-layer heat exchange tube 121, so that the smoke is cooled for the first time to about 250° C.; the smoke that has been cooled for the first time flows along the fourth gap 154 into the third gap 153 so as to exchange heat with the outer-layer heat exchange tube 122, so that the smoke is cooled for the second time to about 70 to 100°° C.; and the smoke that has been cooled for the second time flows along the third gap 153 into the second gap 152. After the smoke flows through the second gap 152, the temperature is further reduced. The smoke flowing into the first gap 151 from the second gap 152 has probably been reduced to 55 to 90° C., and the smoke finally flowing from the first gap 151 to the smoke outlet 114 can be cooled to 50 to 80° C. Thereby, the condensing heat exchanger provided in the embodiments of this application has high heat exchange efficiency and can fully utilize heat in the smoke.

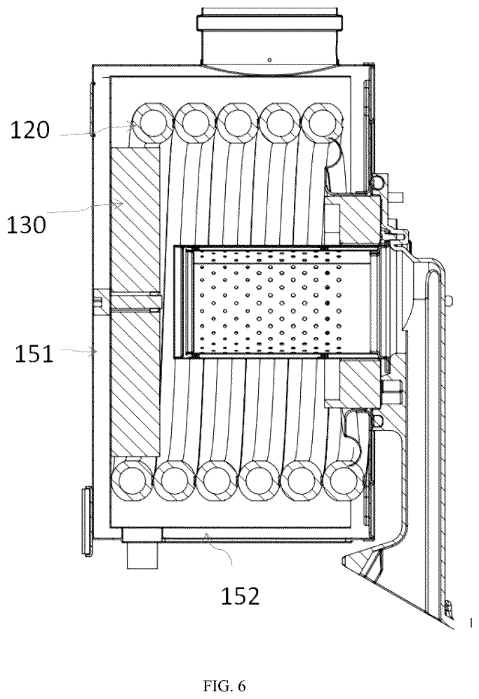

As shown in FIG. 6, in another embodiment, the heat exchange component 120 includes a single-layer heat exchange coil. The heat exchange coil is a finned tube.

In this embodiment, the heat exchange component 120 may only include the single-layer heat exchange coil, and specifically, the heat exchange coil may be a finned tube. When the heat exchange coil is a finned tube, the high-temperature smoke can be guided advantageously to efficiently exchange heat with the heat exchange component 120.

Compared with the form with the double-layer heat exchange coil, the case where the heat exchange component 120 only includes the single-layer heat exchange coil is different mainly in the part of the heat exchange component 120 fitted with the internal structure of the heat exchange component 120. For example, compared with the form with the double-layer heat exchange tube, the second deflector 162 is adaptively eliminated in this embodiment. The high-temperature smoke flowing out of the combustor 200 after exchanging heat with the heat exchange component 120 may sequentially flow into the second gap 152 and the first gap 151 and finally be discharged from the smoke outlet 114.

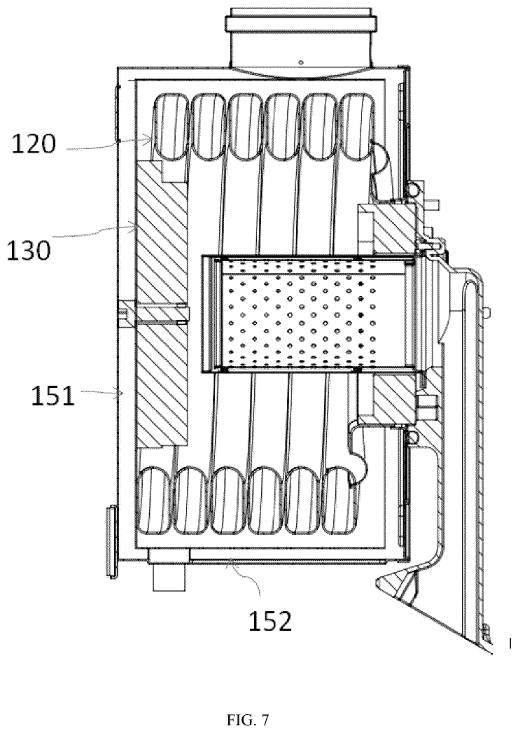

As shown in FIG. 7, in still another embodiment, the heat exchange component 120 includes a single-layer heat exchange coil, and the heat exchange coil has a D-shaped section.

In this embodiment, the heat exchange component 120 may only include the single-layer heat exchange coil, and specifically, the heat exchange coil may have a D-shaped section. Compared with the form with the double-layer heat exchange coil, the case where the heat exchange component 120 only includes the single-layer heat exchange coil is different mainly in the part of the heat exchange component 120 fitted with the internal structure of the heat exchange component 120. Of course, the heat exchange component 120 may also specifically be in other forms. Any form of the heat exchange component shall be included in the scope of the claims of this application, as long as it can be applied to the condensing heat exchanger provided by the disclosure.

Based on the same concept, an embodiment of this application further provides a water heating/heating device including the condensing heat exchanger according to any embodiment above. The combustor 200 and the condensing heat exchanger are fixed on a combustion door. The combustion door is fitted and fixed to the first end portion 111 of the condensing heat exchanger by means of a sealing structure.

The water heating/heating device may be a gas water heater. More specifically, the water heating device may be a condensing water heater, a gas water heater and a wall-mounted residential boiler. Of course, the water heating device may also be a heating stove.

The above embodiments are merely the preferred embodiments of the disclosure, and cannot be used to limit the protection scope of the invention. Any unsubstantial changes and substitutions made by those skilled in the art on the basis of the invention shall fall into the protection scope of the invention.

1. A condensing heat exchanger, comprising:
a housing including a first end portion and a second end portion opposite to each other, and a side wall arranged between the first end portion and the second end portion, the second end portion being provided with a mounting portion for mounting a combustor;
a smoke outlet arranged on the housing;
a heat exchange component arranged inside the housing; and
a first heat insulating member arranged close to the first end portion;
wherein a first gap is provided between the first heat insulating member and the first end portion, and at least part of smoke which has exchanged heat with the heat exchange component can flow through the first gap and be discharged from the smoke outlet.

2. The condensing heat exchanger according to claim 1, wherein a second gap is provided between the heat exchange component and the side wall, the second gap being in communication with the first gap.

3. The condensing heat exchanger according to claim 2, wherein at least part of the smoke which has exchanged heat with the heat exchange component can sequentially flow through the second gap and the first gap and be discharged from the smoke outlet.

4. The condensing heat exchanger according to claim 1, wherein the heat insulating member is provided with a third deflector close to the first end portion, and the first gap is formed between the third deflector and the first end portion.

5. The condensing heat exchanger according to claim 4, wherein a first deflector is arranged between an outer side of the heat exchange component and the side wall of the housing, and the second gap is formed between the first deflector and an inner side wall of the housing, the first deflector being hermetically connected with the third deflector.

6. The condensing heat exchanger according to claim 5, wherein the heat exchange component is a double-layer heat exchange tube including an inner-layer heat exchange tube and an outer-layer heat exchange tube arranged outside the inner-layer heat exchange tube.

7. The condensing heat exchanger according to claim 6, wherein a second deflector is arranged between the inner-layer heat exchange tube and the outer-layer heat exchange tube.

8. The condensing heat exchanger according to claim 5, wherein the first gap is larger than the second gap.

9. The condensing heat exchanger according to claim 7, wherein a third gap is formed between an inner wall of the first deflector and an outer surface of the outer-layer heat exchange tube, and a fourth gap is formed between an inner wall of the second deflector and an outer surface of the inner-layer heat exchange tube, the fourth gap, the third gap, the second gap, and the first gap being sequentially in communication.

10. The condensing heat exchanger according to claim 1, wherein a material of the first heat insulating member comprises any one of vermiculite, refractory bricks, quartz, and fiberglass.

11. The condensing heat exchanger according to claim 1, wherein the condensing heat exchanger further comprises a second heat insulating member arranged close to the second end portion.

12. The condensing heat exchanger according to claim 11, wherein the second heat insulating member comprises a water-cooling smooth tube arranged between the heat exchange component and the second end portion.

13. The condensing heat exchanger according to claim 12, wherein the second heat insulating member further comprises any one or combination of vermiculite, an air chamber and a cooling liquid chamber arranged between the water-cooling smooth tube and the second end portion.

14. The condensing heat exchanger according to claim 1, wherein the side wall of the housing is provided with a drainage groove, which is provided at a lowest point thereof with a water outlet.

15. The condensing heat exchanger according to claim 7, wherein the side wall and the first end portion form a first sleeve with an opening at one end, and the first deflector and the third deflector form a second sleeve with an opening at one end, the openings of the first and second sleeves facing the same direction, the first sleeve surrounding the second sleeve, and a connecting portion being arranged between the first sleeve and the second sleeve.

16. The condensing heat exchanger according to claim 15, wherein the first heat insulating member has a first surface and a second surface opposite to each other along a thickness direction, the first surface being configured to be spaced apart from the combustor at a predetermined distance, and the third deflector being attached to the second surface.

17. The condensing heat exchanger according to claim 16, wherein the connecting portion further comprises an extending portion extending away from the first end portion, and the first heat insulating member is mounted on the extending portion.

18. The condensing heat exchanger according to claim 1, wherein the heat exchange component is in a form of a heat exchange coil which is formed in the middle thereof with a combustion chamber for mounting the combustor, and at least part of the first heat insulating member is located in the combustion chamber.

19. The condensing heat exchanger according to claim 18, wherein the first heat insulating member is in clearance fit with the heat exchange component.

20. The condensing heat exchanger according to claim 19, wherein the first heat insulating member is plunger-shaped as a whole, and a shape of an outer contour of the heat insulating member matches a shape of an inner contour of the heat exchange component.

21. The condensing heat exchanger according to claim 19, wherein along a height direction, a blocking member is further arranged between a top of the first heat insulating member and the heat exchange component.

22. The condensing heat exchanger according to claim 5, wherein a heat exchange tube of the heat exchange component is a finned tube.

23. The condensing heat exchanger according to claim 1, wherein the heat exchange component comprises a single-layer heat exchange coil having a D-shaped section.

24. The condensing heat exchanger according to claim 1, wherein the heat exchange component comprises a single-layer heat exchange coil which is a finned tube.

25. A water heating/heating device, comprising:
the condensing heat exchanger according to claim 1; and
a combustor,
wherein the combustor and the condensing heat exchanger are fixed on a combustion door, which is fitted and fixed to the first end portion of the condensing heat exchanger by means of a sealing structure.
